(19) United States
(12) Patent Application Publication
(10) Pub. No.: US 2019/0075518 A1
(43) Pub. Date: Mar. 7, 2019

(54) SYSTEMS AND METHODS FOR LOW POWER OPERATION OF A WIRELESS COMMUNICATION DEVICE

(71) Applicant: QUALCOMM Incorporated, San Diego, CA (US)

(72) Inventors: Robert Ganton, San Diego, CA (US); Robert Ballam, Eatons Hill (AU)

(21) Appl. No.: 15/841,784

(22) Filed: Dec. 14, 2017

Related U.S. Application Data
(60) Provisional application No. 62/555,204, filed on Sep. 7, 2017.

(51) Int. Cl. H04W 52/02; H04W 64/00; H04W 52/14

(52) U.S. Cl. CPC H04W 52/0225; H04W 64/006; H04W 4/027; H04W 52/143; H04W 52/0216

(57) ABSTRACT

A method by a wireless communication device is described. The method includes determining whether the wireless communication device is moving. The method also includes setting a low advertising rate for transmitting advertising packets in response to determining that the wireless communication device is moving. The method further includes transmitting one or more advertising packets at the low advertising rate.

### RELATED APPLICATIONS

This application is related to and claims priority from U.S. Provisional Patent Application Ser. No. 62/555,204, filed Sep. 7, 2017, for “SYSTEMS AND METHODS FOR LOW POWER OPERATION OF A WIRELESS COMMUNICATION DEVICE.”

### TECHNICAL FIELD

The present disclosure relates generally to communications. More specifically, the present disclosure relates to systems and methods for low power operation of a wireless communication device.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices communicate with other electronic devices. These electronic devices may transmit and/or receive wireless signals. For example, a wireless communication device may communicate with another wireless communication device using radio frequency communication or magnetically coupled communication.

As wireless communication devices have become smaller and smaller, particular challenges have arisen in wireless communications. For example, an inexpensive and small wireless communication device may be used for package tracking. However, battery power in a wireless communication device may be limited. Therefore, systems and methods for improved low power operation may be beneficial.

### SUMMARY

A method by a wireless communication device is described. The method includes determining whether the wireless communication device is moving. The method also includes setting a low advertising rate for transmitting advertising packets in response to determining that the wireless communication device is moving. The method further includes transmitting one or more advertising packets at the low advertising rate

Determining that the wireless communication device is moving may be based on accelerometer measurements.

Setting a low advertising rate when the wireless communication device is moving may include setting the advertising rate to transmit advertising packets at a rate that is a fraction of an advertising rate used when the wireless communication device is stationary.

The method may also include setting a high advertising rate for transmitting advertising packets in response to determining that the wireless communication device is stationary. The method may further include transmitting one or more advertising packets at the high advertising rate.

The method may also include determining that the wireless communication device is stationary longer than an alarm threshold. The method may further include activating an alarm message through advertising packets. The advertising rate for transmitting advertising packets may be increased while the wireless communication device is stationary longer than the alarm threshold. Transmission power of the advertising packets may be increased to enhance detectability of the wireless communication device while the wireless communication device is stationary longer than the alarm threshold.

The wireless communication device may include a package tracking beacon. The wireless communication device may be configured to attach to a package. The wireless communication device may be a Bluetooth low energy (BLE) beacon.

A wireless communication device is also described. The wireless communication device includes a processor, a memory in electronic communication with the processor and instructions stored in the memory. The instructions are executable by the processor to determine whether the wireless communication device is moving. The instructions are also executable to set a low advertising rate for transmitting advertising packets in response to determining that the wireless communication device is moving. The instructions are further executable to transmit one or more advertising packets at the low advertising rate.

A non-transitory tangible computer readable medium for wireless communication storing computer executable code is also described. The computer readable medium includes code for causing a wireless communication device to determine whether the wireless communication device is moving. The computer readable medium also includes code for causing the wireless communication device to set a low advertising rate for transmitting advertising packets in response to determining that the wireless communication device is moving. The computer readable medium further includes code for causing the wireless communication device to transmit one or more advertising packets at the low advertising rate.

An apparatus for wireless communication is also described. The apparatus includes means for determining whether the apparatus is moving. The apparatus also includes means for setting a low advertising rate for transmitting advertising packets in response to determining that the apparatus is moving. The apparatus further includes means for transmitting one or more advertising packets at the low advertising rate.

### BRIEF DESCRIPTION OF THE DRAWINGS

FIG. 1 is a block diagram illustrating a wireless communication device in which improved low power operation may be implemented;

FIG. 2 is a flow diagram illustrating one configuration of a method for improved low power operation by a wireless communication device;

FIG. 3 is a flow diagram illustrating another configuration of a method for improved low power operation by a wireless communication device;

FIG. 4 is a flow diagram illustrating another configuration of a method for improved low power operation by a wireless communication device;

FIG. 5 is a flow diagram illustrating another configuration of a method for improved low power operation by a wireless communication device;

FIG. 6 is a block diagram illustrating a package tracking beacon; and

FIG. 7 illustrates certain components that may be included within a wireless communication device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

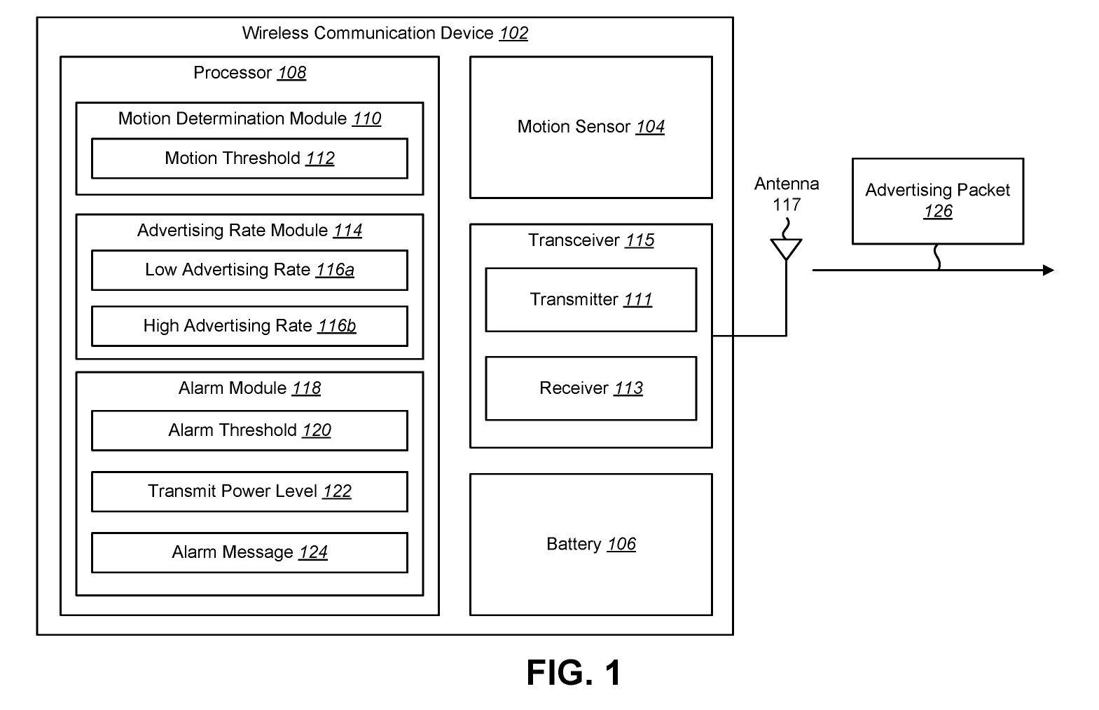

FIG. 1 is a block diagram illustrating a wireless communication device 102 in which improved low power operation may be implemented. The wireless communication device 102 may be included in a wireless communication system. Wireless communication systems are widely deployed to provide various types of communication content such as voice, data and so on.

Communications in the wireless communication system may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) 111 and receiver(s) 113 equipped, respectively, with multiple (N_{T}) transmit antennas 117 and multiple (N_{R}) receive antennas 117 for data transmission. In some configurations, the wireless communication system may utilize MIMO. A MIMO system may support time division duplex (TDD) and/or frequency division duplex (FDD) systems.

In some configurations, the wireless communication system may operate in accordance with one or more standards. Examples of these standards include Bluetooth (e.g., Institute of Electrical and Electronics Engineers (IEEE) 802.15.1), Bluetooth low energy (BLE), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc. Accordingly, the wireless communication device 102 may communicate with a remote device using a communication protocol such as BLE in some configurations.

In some configurations, the wireless communication system may be a multiple-access system capable of supporting communication with multiple wireless communication devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO) systems, single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

In LTE and UMTS, a wireless communication device 102 may be referred to as a “user equipment” (UE). In 3GPP Global System for Mobile Communications (GSM), a wireless communication device 102 may be referred to as a “mobile station” (MS). The wireless communication device 102 and/or remote device may be referred to as and/or may include some or all of the functionality of a UE, MS, terminal, an access terminal, a subscriber unit, a station, etc. Examples of the wireless communication device 102 include cellular phones, smartphones, wireless headsets, wireless speakers, personal digital assistants (PDAs), wireless devices, electronic automobile consoles, gaming systems, wireless controllers, sensors, wireless modems, handheld devices, laptop computers, Session Initiation Protocol (SIP) phones, wireless local loop (WLL) stations, wearable devices, smart watches, etc.

The systems and methods described herein may be implemented on a variety of different electronic devices. Examples of electronic devices include general purpose or special purpose computing system environments or configurations, personal computers (PCs), server computers, handheld or laptop devices, multiprocessor systems, microprocessor-based systems, programmable consumer electronics, network PCs, minicomputers, mainframe computers, distributed computing environments that include any of the above systems or devices and the like. The systems and methods may also be implemented in mobile devices such as phones, smartphones, wireless headsets, personal digital assistants (PDAs), ultra-mobile personal computers (UMPCs), mobile Internet devices (MIDs), etc. Further, the systems and methods may be implemented by battery-operated devices, sensors, etc. The following description refers to wireless communication devices 102 for clarity and to facilitate explanation. Those of ordinary skill in the art will understand that a wireless communication device 102 may comprise any of the devices described above as well as a multitude of other devices.

In yet another configuration, the wireless communication device 102 may be implemented as a beacon device. For example, beacon devices are increasingly used to support tracking of assets and other objects. This application may be referred to as package tracking and the wireless communication device 102 may be referred to as a package tracking beacon.

The wireless communication device 102 may be configured with a transceiver 115 that includes a transmitter 111 and a receiver 113. The transceiver 115 may send and/or receive wireless signals through an antenna 117. The wireless communication device 102 may also be configured with a battery 106 to power the transceiver 115 and a processor 108 (e.g., a microcontroller, controller or microprocessor).

In an implementation, the wireless communication device 102 may be configured as a flat adhesive tracking label. The wireless communication device 102 may be attached (e.g., affixed with an adhesive) to a package for package tracking. In this case, the battery 106 of the wireless communication device 102 should have a small form factor that minimizes the thickness and expense of the wireless communication device 102. In one configuration, the battery 106 may be a coin cell. In another configuration, the battery 106 may be a printed battery.

In order to keep cost and size down and usefulness enhanced, the ability for the wireless communication device 102 to act in a beacon capacity for longer and longer periods of time for similar or lower battery costs is important. Adoption of beacons can be greatly enhanced if this metric is improved. Specifically, when tracking packages, either through shipping or normal delivery channels, a package may be tracked through the use of a beacon device. In an implementation, the wireless communication device 102 may communicate using Bluetooth low energy (BLE) protocols. However, the wireless communication device 102 may also be implemented according to other communication protocols.

The Bluetooth (BT) wireless communication standard is typically employed for exchanging communications between fixed or mobile Bluetooth-enabled devices over short distances. In some configurations, the systems and methods disclosed herein may be applied to establishing connections between Bluetooth-enabled devices configured to operate according to Bluetooth low energy (BLE) standards.

LE refers to the “Low Energy” extension of the Bluetooth standard. The BLE extension is focused on energy-constrained applications such as battery-operated devices, sensor applications, etc. The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices 102 that may not conform to Bluetooth standards.

A BT device may comprise a transmitter 111, a receiver 113 or both a transmitter 111 and a receiver 113. A BT device may also use a frequency-hopping transceiver 115 to combat interference and fading.

BLE systems operate in the unlicensed 2.4 gigahertz (GHz) Industrial-Scientific-Medical (ISM) band at 2.400-2.4835 GHz (2400-2483.5 megahertz (MHz)). As part of the device discovery and connection setup procedure, a BT beacon may transmit advertisement packets 126 on advertising channels. A remote BT device (e.g., a package scanner) may perform periodic scans on the advertising channels to detect these advertisement packets 126.

The systems and methods described herein provide improved low power operation of a beacon device. In an implementation, the wireless communication device 102 may be used in package tracking. However, the wireless communication device 102 may also be used in other applications.

The wireless communication device 102 may determine an advertising rate 116 for transmitting advertising packets 126 based on movement or lack of movement of the wireless communication device 102. In an implementation, the wireless communication device 102 may include a motion sensor 104. The motion sensor 104 may provide measurements from which the motion of the wireless communication device 102 is determined.

The motion sensor 104 may be implemented in one or more configurations. In one configuration, the motion sensor 104 may be an accelerometer. In another configuration, the motion sensor 104 may be implemented as a piezoelectric film that measures motion via changes in voltage when the piezoelectric film is deformed. Other types of motion sensors 104 that may be used include piezoresistive sensors, inductive motion sensor 104, capacitive motion sensors 104 and/or resistive motion sensors 104.

In an approach, the motion sensor 104 may be implemented as an accelerometer that uses interrupts to signal changes in motion. Calculating movement of the wireless communication device 102 via an accelerometer over an extended period of time with a low-power microprocessor and a button cell battery 106 takes a considerable amount of energy. To conserve energy and extend the operational life of the wireless communication device 102, it is desirable to keep complex calculations to a minimum and to allow the processor 108 to enter a low power state most of the time.

In an approach, a wireless communication device may decrease the advertising rate for transmitting advertising packets when motion is detected. For example, in this approach, the wireless communication device does not transmit advertising packets when it is stationary. Then, when the wireless communication device detects motion, the wireless communication device starts to transmit advertising packets. This approach may be useful in a retail inventory monitoring context where an object needs to be tracked only when it is in motion. However, this approach is problematic in a package tracking context.

In a package tracking context, constant monitoring for motion is not warranted. For example, a package on which the wireless communication device 102 is affixed may have periods (e.g., several hours or days) when the package is stationary. Similarly, when the package is in transit (on a truck or airplane, for instance), the package may have long periods when it is motion. Therefore, in this approach, a very low power wireless communication device 102 may utilize the motion sensor 104 (e.g., accelerometer) to monitor for changes in motion.

In this approach, the motion sensor 104 may track motion using a motion threshold 112 and interrupt on the accelerometer. The motion threshold 112 may correlate to expected amounts of shock and/or vibration during shipment. If the accelerometer reads a change in an acceleration value greater than the motion threshold 112, the accelerometer may assert an interrupt to the processor 108.

The processor 108 may periodically monitor the interrupt and keep track of the number of events over a given time period. This can be correlated to whether the wireless communication device 102 is moving or stationary. The wireless communication device 102 may enter different power states (e.g., low power or high power) based on the detected motion or lack of motion.

The wireless communication device 102 may conserve energy (and extend battery life) by determining an advertising rate 116 for transmitting advertising packets 126 based on movement of the wireless communication device 102. For example, normal beacons transmit advertising packets 126 at regular intervals to provide an opportunity for a package tracking device to find and identify them as a tracked object. As the wireless communication device 102 moves, its progress and location can be updated by continuing to receive the beacon transmissions. For example, as a package (with affixed wireless communication device 102) progresses through a sorting facility, scanners may detect advertising packets 126 from the wireless communication device 102. The package may be routed based on the scanned advertising packets 126.

However, when the wireless communication device 102 is moving, it may not be relevant to track its movement. For example, when a package is in transit in a delivery truck or airplane, the location of the package is known. For package tracking there will be periods of travel via airplane and truck during which high-rate advertising will just waste battery energy. In this case, the package may not need to be scanned and the wireless communication device 102 may reduce the rate 116 at which it transmits advertisement packets 126.

The processor 108 may include a motion determination module 110. The motion determination module 110 may determine whether the wireless communication device 102 is moving or stationary based on measurements from the motion sensor 104. For example, the motion determination module 110 may determine that the wireless communication device 102 is moving if the motion sensor 104 measurements exceed a motion threshold 112.

In one approach, the processor 108 may receive a voltage from the motion sensor 104. In this approach, the motion threshold 112 may be a certain voltage level. If the measured voltage level exceeds the motion threshold 112 for a certain period of time, then the motion determination module 110 may determine that the wireless communication device 102 is in a motion state (i.e., the wireless communication device 102 is moving). Alternatively, if the measured voltage level is at or below the motion threshold 112 for a certain period of time, then the motion determination module 110 may determine that the wireless communication device 102 is in a stationary state (i.e., the wireless communication device 102 is not moving).

In an accelerometer interrupt approach, the processor 108 may receive an interrupt signal from the motion sensor 104 when the accelerometer measures motion. In this case, the motion threshold 112 may simply be a received interrupt signal. Upon receiving an interrupt signal, the motion determination module 110 may determine that the wireless communication device 102 is in a motion state. If no interrupt signal is received within a certain period of time, then the motion determination module 110 may determine that the wireless communication device 102 is in a stationary state.

The processor 108 may also include an advertising rate module 114 that determines the advertising rate 116 based on the movement (or lack of movement) of the wireless communication device 102. As used herein, the advertising rate 116 is the number of advertising packets 126 transmitted with respect to time. When the wireless communication device 102 is stationary, then the advertising rate 116 may be set to a high advertising rate 116b that is used in normal operation. For example, in BLE operations, the wireless communication device 102 may transmit advertising packets 126 approximately once per second. It should be noted that other advertising rates 116 may be implemented in accordance with Bluetooth specifications.

It should also be noted that BLE offers advantages in that this communication protocol may perform continuous transmission of advertising packets 126. With some wireless communication protocols (e.g., radio frequency radio-frequency identification (RFID)), a wireless communication device only transmits advertising packets in the presence of a scanner. Therefore, these wireless communication protocols do not offer continuous advertising. BLE, on the other hand, offers continuous advertising, which may be modified with different advertising rates. The continuous advertising that is modified by the advertising rate may improve the detectability and energy efficiency of the wireless communication device 102.

If the wireless communication device 102 is moving (e.g., if the motion determination module 110 determines that a motion threshold 112 has been met), then the advertising rate module 114 may gate off or reduce the interval of the transmission of packets 126 to save battery life and provide enhanced power consumption. In this case, the advertising rate module 114 may set a low advertising rate 116a. For example, during times of continuous movement, the advertising rate 116 may be reduced to approximately once every 10 seconds. If the normal advertising rate 116 is one advertising packet 126 per second, then the low advertising rate 116a used when in motion would consume approximately 1/10th the power of full rate 116 advertising. In yet another configuration, the low advertising rate 116a may be one advertising packet 126 per minute, which results in even greater power savings. In another implementation, the wireless communication device 102 may disable (e.g., turn off) transmission of advertising packets 126 while the wireless communication device 102 is moving. In yet another implementation, the wireless communication device 102 may transmit a burst of advertising packets 126 during a short period of activity that is followed by a long period of inactivity in which no advertising packets 126 are transmitted.

The wireless communication device 102 may switch between the high advertising rate 116b and low advertising rate 116a based on movement conditions. During times of no movement (i.e., when the wireless communication device 102 is in a stationary state) the advertising rate 116 may be increased to the high advertising rate 116b (e.g., once every few seconds) for better tracking feedback. During times of movement (i.e., when the wireless communication device 102 is in a motion state) the advertising rate 116 may be decreased to the low advertising rate 116a (e.g., once every few minutes) to conserve battery power. This allows for a more responsive product with minimal battery requirements allowing for use of a printed battery 106 instead of a coin cell.

The wireless communication device 102 may also enter different power states based on the determined movement. For example, when the wireless communication device 102 is stationary, the wireless communication device 102 may enter a high power state. In this high power state, the processor 108 and/or transceiver 115 may be active for normal operations. However, when the wireless communication device 102 is moving, the wireless communication device 102 may enter a low power state. In this low power state, operations by the processor 108 and/or transceiver 115 may be restricted or disabled to conserve battery power.

The processor 108 may also include an alarm module 118. The alarm module 118 may implement an alert based on lack of movement for a period of time. If the wireless communication device 102 is stationary longer than a programmable alarm threshold 120, then the wireless communication device 102 may assume that it has been lost or there is some other problem. In an implementation, the alarm threshold 120 may be four or more hours that the wireless communication device 102 has remained stationary.

When the alarm threshold 120 has been exceeded, the alarm module 118 may activate an alarm message 124 through BLE advertisements. In a configuration, the alarm message 124 may be included in the protocol data unit (PDU) of the advertising packet 126.

The alarm module 118 may also adjust the advertising rate 116 when the alarm threshold 120 has been exceeded. In one approach, the alarm module 118 may decrease the advertising rate 116 to conserve the batteries during an extended stationary period. In another approach, the alarm module 118 may increase the advertising rate 116 to a high advertising rate 116b to increase the detectability of the wireless communication device 102.

In another implementation, the alarm module 118 may adjust the transmit power level 122 used for transmission of advertising packets 126. For example, the alarm module 118 may increase the transmit power level 122 used by the transmitter 111 over time to enhance the detectability the advertising packets 126. This may make the wireless communication device 102 easier to locate.

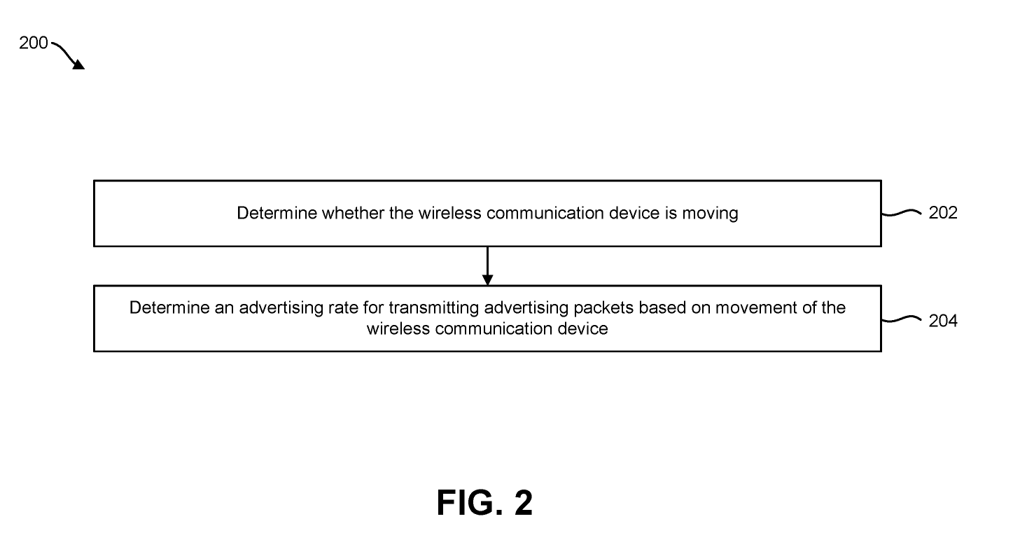

FIG. 2 is a flow diagram illustrating one configuration of a method 200 for improved low power operation by a wireless communication device 102. The wireless communication device 102 may be configured as a package tracking beacon. In an implementation, the wireless communication device 102 may be a BLE beacon.

The wireless communication device 102 may determine 202 whether it is moving. For example, the wireless communication device 102 may detect motion based on accelerometer measurements.

The wireless communication device 102 may determine 204 an advertising rate 116 for transmitting advertising packets 126 based on movement of the wireless communication device 102. For example, the advertising rate 116 may be decreased when the wireless communication device 102 is moving. In one approach, decreasing the advertising rate 116 may include setting the advertising rate 116 to transmit advertising packets 126 at a rate 116 that is a fraction of the normal advertising rate 116 used when the wireless communication device 102 is stationary. In another approach, decreasing the advertising rate 116 may include disabling transmission of advertising packets 126 while the wireless communication device 102 is moving.

The advertising rate 116 may be increased when the wireless communication device 102 is stationary. For example, increasing the advertising rate 116 may include setting the advertising rate 116 to transmit advertising packets 126 one or more times within a number of seconds.

If the wireless communication device 102 determines that it has been stationary longer than an alarm threshold 120, then the wireless communication device 102 may activate an alarm message 124 through advertising packets 126. The wireless communication device 102 may decrease the advertising rate 116 for transmitting advertising packets 126 while the wireless communication device 102 is stationary. The wireless communication device 102 may increase the transmission power of the advertising packets 126 to enhance detectability of the wireless communication device 102.

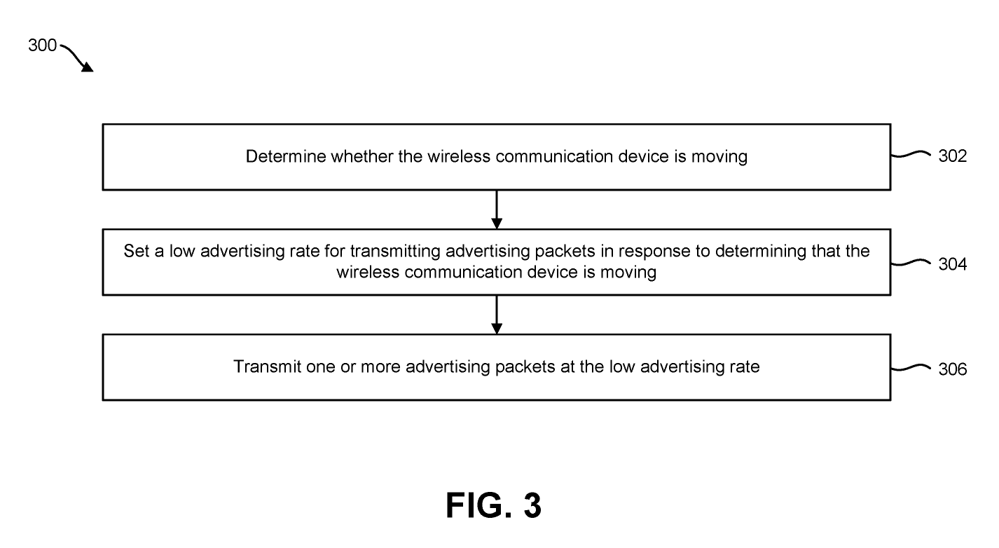

FIG. 3 is a flow diagram illustrating another configuration of a method 300 for improved low power operation by a wireless communication device 102. The wireless communication device 102 may be configured to attach to a package. For example, the wireless communication device 102 may be a package tracking beacon. In an implementation, the wireless communication device 102 may be a BLE beacon.

The wireless communication device 102 may determine 302 whether it is moving. For example, the wireless communication device 102 may detect motion based on accelerometer measurements.

The wireless communication device 102 may set 304 a low advertising rate 116a for transmitting advertising packets 126 in response to determining that the wireless communication device 102 is moving. For example, the wireless communication device 102 may set 304 the advertising rate 116 to transmit advertising packets 126 at a rate that is a fraction of an advertising rate used when the wireless communication device is stationary. In other words, the low advertising rate 116a used when the wireless communication device 102 is in motion may be substantially less than the high advertising rate 116b used when the wireless communication device 102 is stationary.

In some implementations, the low advertising rate 116a used when the wireless communication device 102 is moving may be 1/10th the normal advertising rate 116 (i.e., the high advertising rate 116b). If the high (stationary) advertising rate 116b is approximately 1 advertising packet 126 per second, the low (moving) advertising rate 116a may be 1 advertising packet 126 per 10 seconds. In another approach, setting 304 the low advertising rate 116a may include setting 304 the advertising rate 116 to transmit advertising packets 126 once within a number of minutes.

The wireless communication device 102 may transmit 306 one or more advertising packets 126 at the low advertising rate 116a. For example, the wireless communication device 102 may transmit 306 advertising packets 126 on one or more advertising channels. The wireless communication device 102 may continue to transmit 306 advertising packets 126 at the low advertising rate 116a while the wireless communication device 102 is in motion.

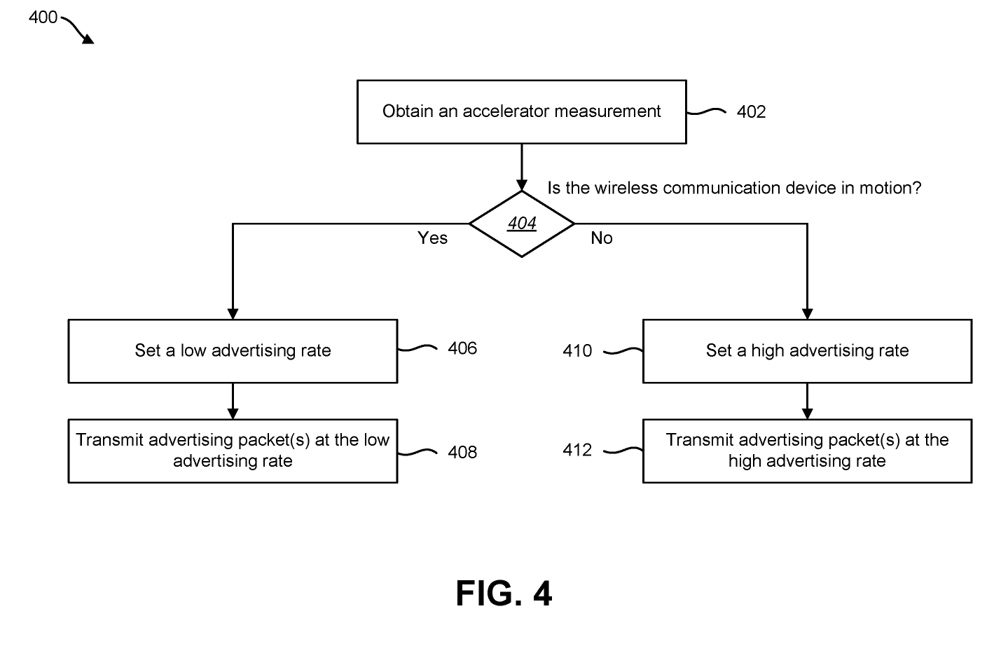

FIG. 4 is a flow diagram illustrating another configuration of a method 400 for improved low power operation by a wireless communication device 102. The wireless communication device 102 may be configured with an accelerometer to detect motion.

The wireless communication device 102 may obtain 402 an accelerometer measurement. The accelerometer measurement may indicate whether the wireless communication device 102 is stationary or in motion.

The wireless communication device 102 may determine 404 whether it is in motion. For example, the wireless communication device 102 may determine whether the accelerometer measurement is greater than a motion threshold 112. If the wireless communication device 102 is in motion, then the wireless communication device 102 may set 406 a low advertising rate 116a. The low advertising rate 116a may be substantially less than a high advertising rate 116b (also referred to as a normal advertising rate) used when the wireless communication device 102 is stationary. In some implementations, the low advertising rate 116a may be approximately one advertising packet 126 per 10 seconds. The wireless communication device 102 may then transmit 408 one or more advertising packets 126 at the low advertising rate 116a.

If the wireless communication device 102 determines 404 that it is stationary (e.g., if the accelerometer measurement is below a motion threshold 112), then the wireless communication device 102 may set 410 a high advertising rate 116b. In some implementations, the high advertising rate 116b may be approximately one advertising packet 126 per second. The wireless communication device 102 may then transmit 412 one or more advertising packets 126 at the high advertising rate 116b.

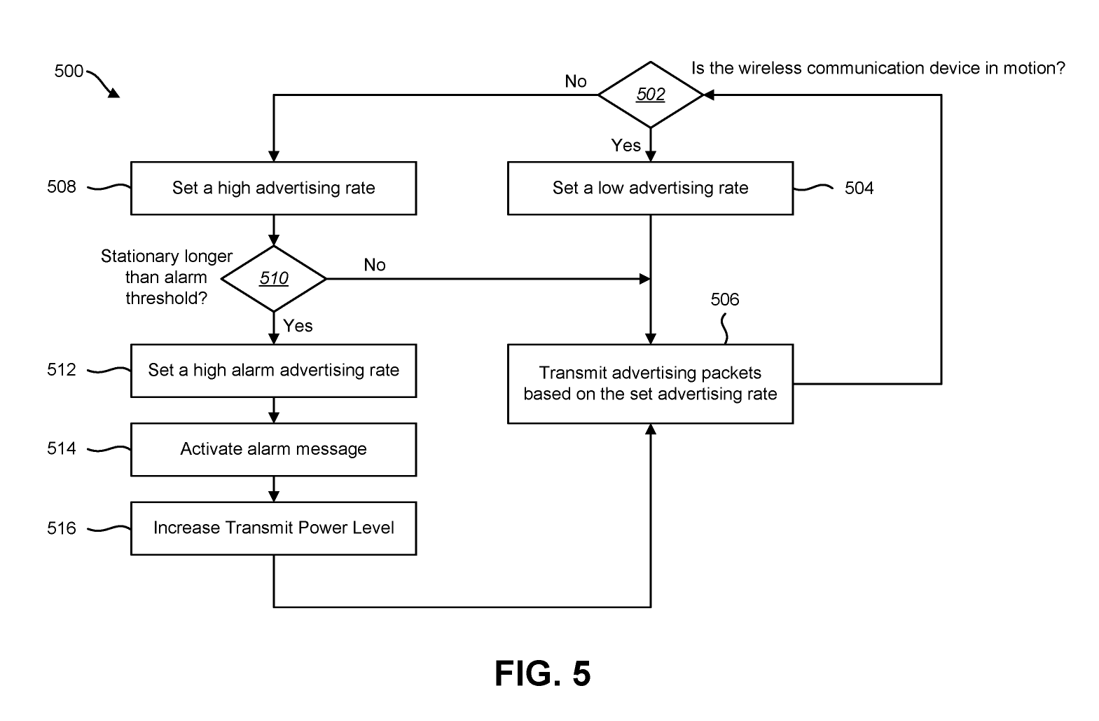

FIG. 5 is a flow diagram illustrating another configuration of a method 500 for improved low power operation by a wireless communication device 102. The wireless communication device 102 may include an accelerometer for detecting motion. The wireless communication device 102 may also include a battery 106 to power wireless communications.

The wireless communication device 102 may determine 502 whether it is in motion. For example, using the accelerometer measurements, the wireless communication device 102 may determine whether a motion threshold 112 has been exceeded, which indicates that the wireless communication device 102 is moving.

If the wireless communication device 102 is in motion, the wireless communication device 102 may set 504 a low advertising rate 116a. For example, the wireless communication device 102 may set 504 the advertising rate 116 for transmitting advertising packets 126 to one advertising packet 126 per minute. The wireless communication device 102 may then transmit 506 the advertising packets 126 based on the set advertising rate 116 (e.g., low advertising rate 116a). When the wireless communication device 102 is in motion, the wireless communication device 102 may also enter a low power state (e.g., disable or reduce functionality of the processor 108 or transceiver 115) to further conserve battery power.

If the wireless communication device 102 determines 502 that it is not in motion (i.e., the wireless communication device 102 is stationary), then the wireless communication device 102 may set 508 a high advertising rate 116b. For example, the wireless communication device 102 may set 508 the advertising rate 116 for transmitting advertising packets 126 to one or more advertising packets 126 per second. If the wireless communication device 102 determines 510 that it has not been stationary longer than an alarm threshold 120, the wireless communication device 102 may transmit 506 the advertising packets 126 based on the set advertising rate 116 (e.g., high advertising rate 116b). When the wireless communication device 102 is stationary, the wireless communication device 102 may also enter a high power state (e.g., enable functionality of the processor 108 and transceiver 115) for normal operation.

If the wireless communication device 102 determines 510 that it has been stationary for longer than an alarm threshold 120, the wireless communication device 102 may set 512 a high alarm advertising rate 116b (e.g., one or more advertising packets 126 per second). If there is an alarm condition for being stationary for too long, the wireless communication device 102 may set the advertising interval to be a shorter time period at higher power in order to get the attention of any BLE scanner that is nearby. For example, the normal stationary advertising rate 116 could be in the 1-2 second range, but with an alarm condition the advertising rate 116 could be increased to once every 0.2 seconds (or some similar value).

The wireless communication device 102 may also activate 514 an alarm message 124 through the advertising packets 126. The wireless communication device 102 may additionally increase 516 the transmit power level 122 of the advertising packets 126. The wireless communication device 102 may then transmit the advertising packets 126 based on the set advertising rate 116.

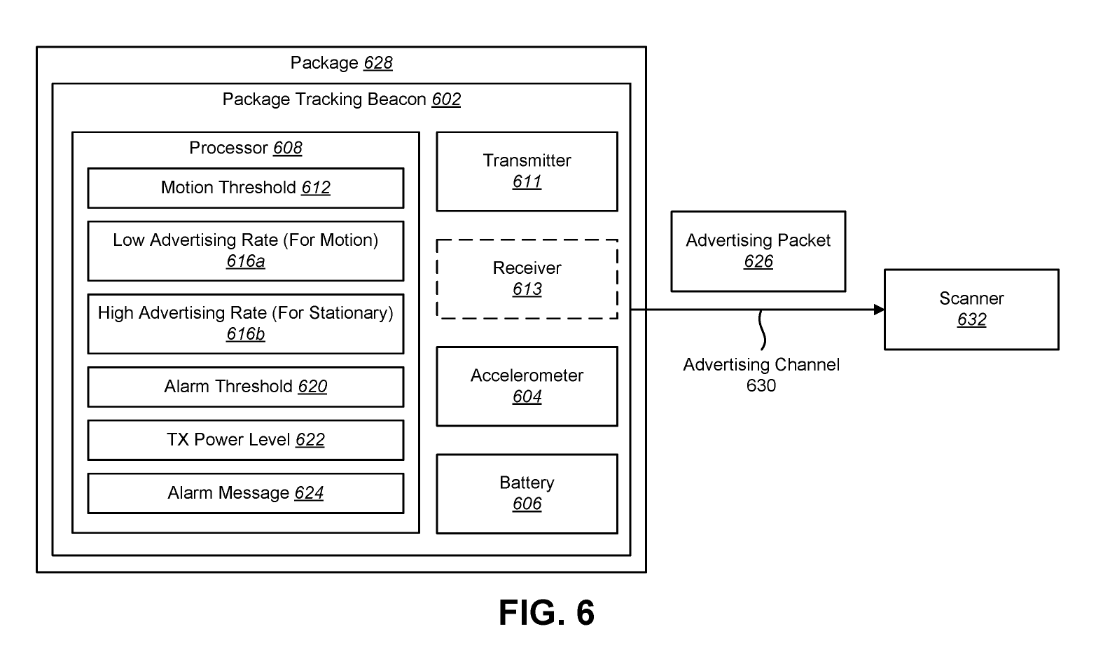

FIG. 6 is a block diagram illustrating a package tracking beacon 602. The package tracking beacon 602 may be implemented in accordance with the wireless communication device 102 described in connection with FIG. 1. The package tracking beacon 602 may be configured to attach to a package 628. Examples of a package 628 include envelopes, bags, boxes and satchels.

The package tracking beacon 602 may transmit advertising packets 626 on an advertising channel 630. For example, the package tracking beacon 602 may use Bluetooth low energy (BLE) protocols to transmit the advertising packets 626 on one or more advertising channels 630. A scanner 632 may perform scans to detect the advertising packets 626 on the one or more advertising channels 630.

In some implementations, the package tracking beacon 602 may be configured to attach to a package 628 with an adhesive. For example, a surface of the package tracking beacon 602 may be coated with an adhesive with which the package tracking beacon 602 is bonded to the package 628. In other implementations, the package tracking beacon 602 may be configured to attach to the package 628 with non-adhesive attachment mechanisms (e.g., bands, straps, hook and loop systems, screws, nails, tape, etc.). In yet other implementations, the package tracking beacon 602 may be configured to be included within the package 628. For example, the package tracking beacon 602 may be configured with a flat shape that can easily fit within an envelope or box.

In some implementations, the package tracking beacon 602 may be a label (e.g., shipping label) associated with a package 628. For example, the package tracking beacon 602 may be configured as a flat, adhesive-backed shipping label. The package tracking beacon 602 may be attached (e.g., affixed with an adhesive) to the package 628 for package tracking.

The package tracking beacon 602 includes a transmitter 611 that transmits advertising packets 626. The package tracking beacon 602 may also include a battery 606 to provide power to the transmitter 611 and other circuitry (e.g., processor 608, memory, etc.). The package tracking beacon 602 may (optionally) include a receiver 613. For example, in one implementation, the package tracking beacon 602 may only include the transmitter 611 without a receiver 613. In this implementation, the package tracking beacon 602 may include a switch or other means of activating the transmission of advertising packets 626.

In other (optional) implementations, the package tracking beacon 602 may include a receiver 613. In these implementations, a scanner 632 may communicate with the package tracking beacon 602. In this case, the package tracking beacon 602 may receive a command to start transmitting advertising packets 626. For example, a user may attach the package tracking beacon 602 to a package 628. At some point, the package tracking beacon 602 may be scanned by a scanner 632 and the package tracking beacon 602 may start broadcasting advertising packets 626.

The package tracking beacon 602 may be configured with an accelerometer 604. The accelerometer 604 may measure the motion of the package tracking beacon 602. For example, changes in measured acceleration of the package tracking beacon 602 may indicate that the package tracking beacon 602 is in motion. The package tracking beacon 602 may experience vibrations while in motion. For example, when the package tracking beacon 602 is moving in a vehicle, the accelerometer 604 may detect changes in acceleration due to the movement of the vehicle.

The package tracking beacon 602 may determine whether it is in motion based on a motion threshold 612. For example, the package tracking beacon 602 may determine whether the accelerometer measurement(s) exceed the motion threshold 612. The motion threshold 612 may be configured to be high enough that noise measured by the accelerometer 604 (due to subtle vibrations, for instance) does not result in a false motion determination.

When the package tracking beacon 602 determines that it is in motion, the package tracking beacon 602 may set a low advertising rate 616a for transmitting advertising packets 626 on the advertising channel 630. Alternatively, when the package tracking beacon 602 determines that it is stationary, then the package tracking beacon 602 may set a high advertising rate 616b for transmitting advertising packets 626. The high advertising rate 616b may be the normal advertising rate used. The low advertising rate 616a may offer significant energy savings when the package 628 is in transit and does not need to be scanned by a scanner 632, whereas the high advertising rate 616b provides responsiveness to a package tracking system.

The package tracking beacon 602 may implement an alarm mode when it has been stationary longer than an alarm threshold 620. If the accelerometer 604 does not register motion for more than the alarm threshold 620, then the package tracking beacon 602 may increase the TX power level 622 for the advertising packets 626. This may improve the detectability of the advertising packets 626 by a scanner 632. The package tracking beacon 602 may also include an alarm message 624 in the advertising packets 626 to indicate to a scanner 632 that there is a problem.

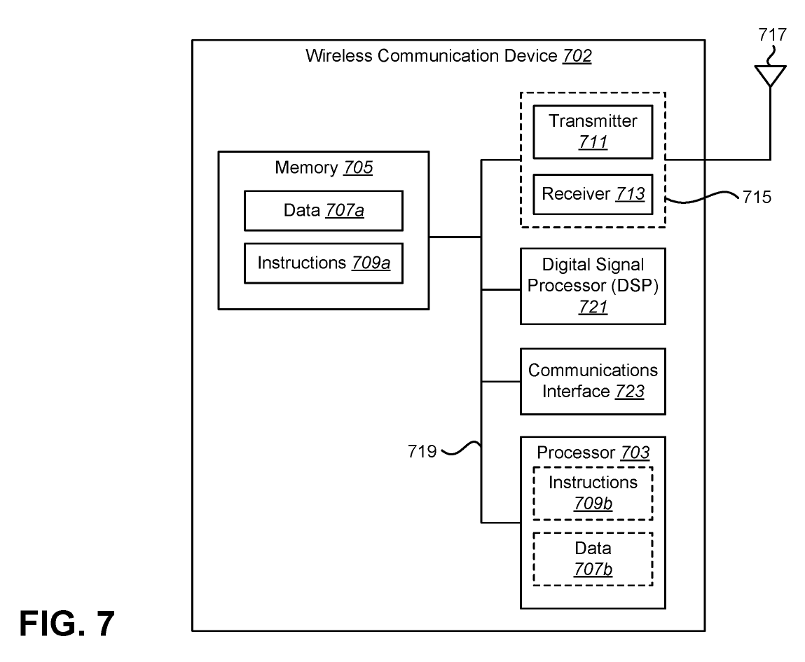

FIG. 7 illustrates certain components that may be included within a wireless communication device 702. The wireless communication device 702 described in connection with FIG. 7 may be an example of and/or may be implemented in accordance with the wireless communication device described in connection with one or more of FIGS. 1-6.

The wireless communication device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705 in electronic communication with the processor (i.e., the processor can read information from and/or write information to the memory). The memory 705 may be any electronic component capable of storing electronic information. The memory 705 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 707a and instructions 709a may be stored in the memory 705. The instructions may include one or more programs, routines, sub-routines, functions, procedures, code, etc. The instructions may include a single computer-readable statement or many computer-readable statements. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. The wireless communication device 702 may also include (not shown) multiplier transmitters, multiplier antennas, multiplier receivers and/or multiplier transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C.

As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C.

As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method by a wireless communication device, comprising:
determining whether the wireless communication device is moving;
setting a low advertising rate for transmitting advertising packets in response to determining that the wireless communication device is moving; and
transmitting one or more advertising packets at the low advertising rate.

2. The method of claim 1, wherein determining that the wireless communication device is moving is based on accelerometer measurements.

3. The method of claim 1, wherein setting a low advertising rate when the wireless communication device is moving comprises setting the advertising rate to transmit advertising packets at a rate that is a fraction of an advertising rate used when the wireless communication device is stationary.

4. The method of claim 1, further comprising:
setting a high advertising rate for transmitting advertising packets in response to determining that the wireless communication device is stationary; and
transmitting one or more advertising packets at the high advertising rate.

5. The method of claim 1, further comprising:
determining that the wireless communication device is stationary longer than an alarm threshold; and
activating an alarm message through advertising packets.

6. The method of claim 5, further comprising:
increasing the advertising rate for transmitting advertising packets while the wireless communication device is stationary longer than the alarm threshold.

7. The method of claim 5, further comprising:
increasing transmission power of the advertising packets to enhance detectability of the wireless communication device while the wireless communication device is stationary longer than the alarm threshold.

8. The method of claim 1, wherein the wireless communication device comprises a package tracking beacon.

9. The method of claim 8, wherein the wireless communication device is configured to attach to a package.

10. The method of claim 1, wherein the wireless communication device is a Bluetooth low energy (BLE) beacon.

11. A wireless communication device, comprising:
a processor;
a memory in electronic communication with the processor; and
instructions stored in the memory, the instructions executable by the processor to:
determine whether the wireless communication device is moving;
set a low advertising rate for transmitting advertising packets in response to determining that the wireless communication device is moving; and
transmit one or more advertising packets at the low advertising rate.

12. The wireless communication device of claim 11, wherein the instructions executable to set the low advertising rate when the wireless communication device is moving comprise instructions executable to set the advertising rate to transmit advertising packets at a rate that is a fraction of an advertising rate used when the wireless communication device is stationary.

13. The wireless communication device of claim 11, further comprising instructions executable to:
set a high advertising rate for transmitting advertising packets in response to determining that the wireless communication device is stationary; and
transmit one or more advertising packets at the high advertising rate.

14. The wireless communication device of claim 11, further comprising instructions executable to:
determine that the wireless communication device is stationary longer than an alarm threshold; and
activate an alarm message through advertising packets.

15. The wireless communication device of claim 14, further comprising instructions executable to:
increase the advertising rate for transmitting advertising packets while the wireless communication device is stationary longer than the alarm threshold.

16. The wireless communication device of claim 14, further comprising instructions executable to:
increase transmission power of the advertising packets to enhance detectability of the wireless communication device while the wireless communication device is stationary longer than the alarm threshold.

17. The wireless communication device of claim 11, wherein the wireless communication device comprises a package tracking beacon.

18. A non-transitory tangible computer readable medium for wireless communication storing computer executable code, comprising:
code for causing a wireless communication device to determine whether the wireless communication device is moving;
code for causing the wireless communication device to set a low advertising rate for transmitting advertising packets in response to determining that the wireless communication device is moving; and
code for causing the wireless communication device to transmit one or more advertising packets at the low advertising rate.

19. The computer readable medium of claim 18, wherein code for causing the wireless communication device to set the low advertising rate when the wireless communication device is moving comprises code for causing the wireless communication device to set the advertising rate to transmit advertising packets at a rate that is a fraction of an advertising rate used when the wireless communication device is stationary.

20. The computer readable medium of claim 18, further comprising:
code for causing the wireless communication device to set a high advertising rate for transmitting advertising packets in response to determining that the wireless communication device is stationary; and
code for causing the wireless communication device to transmit one or more advertising packets at the high advertising rate.

21. The computer readable medium of claim 18, further comprising:
code for causing the wireless communication device to determine that the wireless communication device is stationary longer than an alarm threshold; and
code for causing the wireless communication device to activate an alarm message through advertising packets.

22. The computer readable medium of claim 21, further comprising:
code for causing the wireless communication device to increase the advertising rate for transmitting advertising packets while the wireless communication device is stationary longer than the alarm threshold.

23. The computer readable medium of claim 21, further comprising:
code for causing the wireless communication device to increase transmission power of the advertising packets to enhance detectability of the wireless communication device while the wireless communication device is stationary longer than the alarm threshold.

24. The computer readable medium of claim 18, wherein the wireless communication device comprises a package tracking beacon.

25. An apparatus for wireless communication, comprising:
means for determining whether the apparatus is moving;
means for setting a low advertising rate for transmitting advertising packets in response to determining that the apparatus is moving; and
means for transmitting one or more advertising packets at the low advertising rate.

26. The apparatus of claim 25, wherein the means for setting a low advertising rate when the apparatus is moving comprise means for setting the advertising rate to transmit advertising packets at a rate that is a fraction of an advertising rate used when the apparatus is stationary.

27. The apparatus of claim 25, further comprising:
means for setting a high advertising rate for transmitting advertising packets in response to determining that the apparatus is stationary; and
means for transmitting one or more advertising packets at the high advertising rate.

28. The apparatus of claim 25, further comprising:
means for determining that the apparatus is stationary longer than an alarm threshold; and
means for activating an alarm message through advertising packets.

29. The apparatus of claim 28, further comprising:
means for increasing the advertising rate for transmitting advertising packets while the apparatus is stationary longer than the alarm threshold.

30. The apparatus of claim 28, further comprising:
means for increasing transmission power of the advertising packets to enhance detectability of the apparatus while the apparatus is stationary longer than the alarm threshold.
